(19) United States
(12) Patent Application Publication
(10) Pub. No.: US 2024/0358205 A1
(43) Pub. Date: Oct. 31, 2024

(54) IMPELLER AND CLEANER USING SAME

(71) Applicant: Samsung Electronics Co., Ltd., Suwon-si (KR)

(72) Inventors: Masayuki TAKADA, Yokohama-shi (JP); Minoru YOSHIDA, Yokohama-shi (JP)

(21) Appl. No.: 18/680,262

(22) Filed: May 31, 2024

Related U.S. Application Data
(63) Continuation of application No. PCT/KR2024/003641, filed on Mar. 22, 2024.

(30) Foreign Application Priority Data
Apr. 28, 2023 (JP) 2023-074199

(51) Int. Cl. A47L 5/28; F04D 29/30; F04D 29/38

(52) U.S. Cl. CPC A47L 5/28; F04D 29/30; F04D 29/384; F05D 2240/303

(57) ABSTRACT

A cleaner includes an impeller generating a suction force within the cleaner, in an airflow direction, a base portion having an increasing diameter in the airflow direction, and blades each protruding from the base portion, in a direction opposite to the airflow direction, and tilted backward in a direction opposite to the rotational direction. A wind-cutting edge of the blades faces the airflow direction and includes a proximal end closest to the boss portion along the radial direction and meeting the base portion, a protruding end furthest from the boss portion along the radial direction and spaced apart from the base portion along the airflow direction, a protruding curved portion convexly curved in the rotational direction, and a recessed curved portion concavely curved in the direction opposite to the rotational direction, the recessed curved portion being closer to the protruding end than the protruding curved portion.

### CROSS-REFERENCE TO RELATED APPLICATIONS

This application is a continuation application of International Application No. PCT/KR2024/003641 designating the United States, filed on Mar. 22, 2024, in the Korean Intellectual Property Receiving Office and claiming priority to Japanese Patent Application No. 2023-074199, filed on Apr. 28, 2023, in the Japanese Intellectual Property Office, the disclosures of which are incorporated by reference herein in their entireties.

### BACKGROUND

### (1) Field

The present disclosure relates to an impeller and a suction device such as a cleaner using the same.

### (2) Description of the Related Art

There are small, lightweight stick-type cleaners as suction devices which operate wirelessly and are easy to handle. Stick-type cleaners are equipped with a small impeller having a diameter of about 3 centimeters (cm) to about 5 cm. In order to generate a high suction force with such a small impeller, a small and lightweight motor capable of rotating at a high speed of 50,000 revolutions per minute (rpm) or more while delivering a suitable amount of torque has been used as a motor for rotating the impeller.

Japanese Patent Laid-Open No. 2014-118833 discloses the shape of a leading edge of a blade. The leading edge corresponds to a wind-cutting edge. According to the above literature, in order to suppress the development of shock waves generated during high-speed rotation, the leading edge of the blade is curved concavely in a reverse rotational direction (e.g., a direction opposite to a rotational direction of the blade) from its proximal end to its middle portion, and is curved convexly in a rotational direction (e.g., the rotational direction of the blade) from its middle portion to its protruding end.

### SUMMARY

Since suction devices such as stick-type cleaners operate using a relatively high suction force equal to or higher than that of comparative canister-type cleaners, high-speed rotation of motors is progressing such that motors that rotate at ultra-high speeds exceeding 100,000 rpm have been realized. Accordingly, impellers within such motors are being designed to have high performance.

According to an aspect of the present disclosure, a cleaner includes a main body portion including a filtration chamber and an exhaust chamber, and a dust case connected to the main body portion. An impeller is disposed in the main body portion. The impeller generates a suction force to suck air from the dust case into the main body portion through an air passage, while being rotated by a motor. The impeller includes a boss portion to which a shaft of the motor is fixed, a base portion which slopes downward from an upstream side of the air passage toward a downstream side of the air passage, based on the boss portion, and has a diameter which gradually increases from the upstream side of the air passage toward the downstream side of the air passage, and a plurality of blades disposed radially on the base portion to generate a suction force in the air passage. Each of the plurality of blades includes a wind-cutting edge close to the boss portion, The wind-cutting edge includes a proximal end on the side of the base portion and a protruding end spaced apart from the base portion. The wind-cutting edge includes a protruding curved portion convexly curved in a rotational direction of the impeller at a portion close to the proximal end, and a recessed curved portion concavely curved in a direction opposite to the rotational direction at a portion close to the protruding end.

According to an aspect of the present disclosure, an impeller is installed on an air passage to generate a suction force while being rotated by a motor. The impeller includes a boss portion, a base portion connected to the boss portion, and a plurality of blades provided on the base portion. A shaft of the motor is fixed to the boss portion. The base portion includes an inclined surface which slopes downward from an upstream side of the air passage toward a downstream side of the air passage and has a diameter which gradually increases from the upstream side of the air passage toward the downstream side of the air passage. The plurality of blades protrude from the inclined surface of the base portion. The plurality of blades extend to be shifted backward with respect to the rotational direction as going outward in a radial direction from the boss portion. Each of the plurality of blades may have a swept-back wing shape. Each of the plurality of blades includes a wind-cutting edge close to the boss portion, The wind-cutting edge includes a proximal end on the side of the base portion and a protruding end spaced apart from the base portion. The wind-cutting edge includes a protruding curved portion convexly curved in a rotational direction of the impeller at a portion close to the proximal end, and a recessed curved portion concavely curved in a direction opposite to the rotational direction at a portion close to the protruding end.

### BRIEF DESCRIPTION OF THE DRAWINGS

The above and other advantages and features of this disclosure will become more apparent by describing in further detail embodiments thereof with reference to the accompanying drawings, in which:

FIG. 1A is a perspective view of a cleaner as a suction device according to an embodiment of the present disclosure.

FIG. 1B is a side view of the cleaner in FIG. 1A.

FIG. 1C is an enlarged cross-sectional view of region C1 in FIG. 1B.

FIG. 2 is an enlarged cross-sectional view of a blower according to an embodiment of the present disclosure.

FIGS. 3A and 3B respectively illustrate a top plan view and a side view of an impeller according to an embodiment of the present disclosure.

FIG. 4 is a perspective view of an impeller according to an embodiment of the present disclosure.

FIG. 5A illustrates a top plan of a wind-cutting edge of a blade according to an embodiment of the present disclosure.

FIG. 5B illustrates an enlarged top plan view of region C2 in FIG. 5A.

FIG. 5C illustrates a side view of the blade in FIG. 5B.

FIGS. 6A and 6B are side view illustrating fluid analysis results of an impeller according to a Comparative Example and to an embodiment of the present disclosure.

### DETAILED DESCRIPTION

It should be understood that various embodiments of the disclosure in this document and terms used therein are not intended to limit the technical features described herein to particular embodiments of the disclosure and that the disclosure includes various modifications, equivalents, or substitutions of the embodiments of the disclosure.

With regard to the description of the drawings, like reference numerals may be used to represent like or related elements. Within the Figures and the text of the disclosure, a reference number indicating a singular form of an element may also be used to reference a plurality of the singular element.

A singular form of a noun corresponding to an item may include one or a plurality of the items unless the context clearly indicates otherwise. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise.

As used herein, each of the phrases such as “A or B,” “at least one of A and B, “at least one of A or B,” “A, B, or C,” “at least one of A, B, and C,” and “at least one of A, B, or C” may include any one of the items listed together in a corresponding one of the phrases, or all possible combinations thereof.

The term “and/or” includes any combination of a plurality of associated elements listed, or any one of the plurality of associated listed elements.

Terms such as “first,” “second,” etc. may be used simply to distinguish an element from other elements and do not limit the elements in any other respect (e.g., importance or order).

It will be understood that when an element (e.g., a first element) is referred to, with or without the term “functionally” or “communicatively”, as being “coupled” or “connected” to another element (e.g., a second element), the element may be coupled to the other element directly (e.g., in a wired manner), wirelessly, or via a third element.

The terms such as “comprise,” “include,” or “have” are intended to specify the presence of stated features, numbers, steps, operations, elements, components, or combinations thereof, but do not preclude the presence or addition of one or more other features, numbers, steps, operations, elements, components, or combinations thereof.

It will also be understood that when an element is referred to as being related to another element such as being “connected,” “coupled,” “supported,” or “in contact” with another element, this includes not only when the elements are directly connected, coupled, supported, or in contact, but also when they are indirectly connected, coupled, supported, or in contact via a third element.

It will also be understood that when an element is referred to as being related to another element such as being “on” another element, the element may be directly on the other element, or intervening elements may also be present therebetween. In contrast, when an element is referred to as being relate to another element such as being “directly connected,” “directly coupled,” “directly supported,” “directly in contact,” “directly on” and the like, no third element or intervening element is present therebetween.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A cleaner, for example, a cordless stick type cleaner, is provided with a blower. The blower includes an impeller and a motor which rotates the impeller. In order to realize high suction power, motors are becoming smaller and faster, and, along with this, impellers are also required to be smaller and have higher performance. The present disclosure provides a high-performance impeller suitable for high-speed rotation or ultra-high-speed rotation, and a cleaner employing the high-performance impeller. The present disclosure provides a small impeller capable of improving a high suction force, and a cleaner employing the small impeller. However, the technical problems to be achieved in this document are not limited to the above-mentioned technical problems, and other technical problems not mentioned will be clearly understood by a person skilled in the art to which the disclosure pertains from the following description.

An impeller and a cleaner employing the same, according to embodiments of the present disclosure, will now be described more fully with reference to the accompanying drawings so that the embodiments may be easily performed by one of ordinary skill in the art to which the present disclosure pertains. The present disclosure may, however, be embodied in many different forms and should not be construed as being limited to the embodiments set forth herein. In the drawings, parts irrelevant to the description are omitted for the simplicity of explanation, and like numbers refer to like elements throughout.

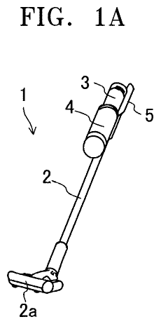

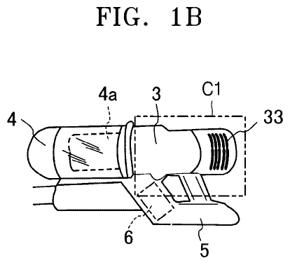

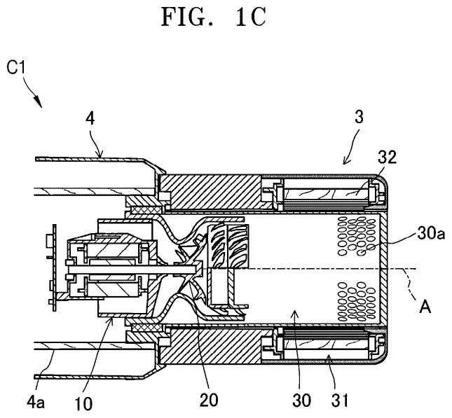

FIG. 1A is a perspective view of a cleaner as a suction device according to an embodiment of the present disclosure. FIG. 1B is a side view of the cleaner in FIG. 1A. The cleaner of FIGS. 1A to 1C is a stick type cleaner 1. The stick type cleaner 1 will now be referred to as a cleaner 1. The cleaner 1 may be of a wireless type.

An impeller 20 according to an embodiment of the present disclosure is mounted in the cleaner 1. The cleaner 1 may include a main body 3 including a filtration chamber 31 and an exhaust chamber 30, and a dust case 4 which is connected to the main body 3. The cleaner 1 according to an embodiment of the present disclosure may further include a pipe 2 and a handle 5. The handle 5 is a part which a user holds, with which the cleaner 1 can be moved, and is connected to the main body 3. The cleaner 1 is capable of being used by one hand of the user, such as by the user holding the handle 5 with one hand.

The pipe 2 may be an elongated, cylindrical member. A head 2a of the cleaner 1 (e.g., a cleaner head) at which material (e.g., dirt, dust, etc.) is suctioned into the cleaner 1 from outside thereof, is mounted at an end portion (e.g., a first end) of the pipe 2 which is furthest from the handle 5 along a length of the cleaner 1. The main body 3 and the handle 5 may be integrated with another end portion of the pipe 2 (e.g., a second end opposite to the first end).

A blower 10 is accommodated in the main body 3. A battery 6 may be accommodated in the handle 5. The battery 6 may be a rechargeable secondary battery, and supplies electrical energy to the blower 10. The electric energy supplied from the battery 6 may drive a motor 13, which will be described later, installed in the blower 10 to rotate the impeller 20.

The dust case 4 is installed below the main body 3, in a direction along the length of the cleaner 1. The dust case 4 may be detachable from the main body 3 (e.g., detachably attachable). When the blower 10 is driven, a strong suction force is generated at the head 2a, in a direction from outside the head 2a to inside the head 2a. Dust suctioned through the head 2a from outside the cleaner 1 may be collected in the dust case 4, through the pipe 2. Here, opposing ends of the pipe 2 may be in communication with inner areas of both the head 2a and the dust case 4.

Referring to a portion of FIG. 1C as a magnification of the internal structure of the main body 3, the main body 3 may include an exhaust chamber 30, a filtration chamber 31, etc. which is defined inside the main body 3. The exhaust chamber 30 may be a cylindrical space with a closed end and an open end which is opposite to the closed end, and an exhaust member including a plurality of inner exhaust holes 30a formed (or provided) along an outer circumferential surface of a body of the exhaust chamber 30. The filtration chamber 31 may surround the exhaust chamber 30 in an end view of the cleaner 1 (e.g., a view along the length of the cleaner 1). In the filtration chamber 31, a cylindrical filter 32 for capturing dust may be positioned around an entire outer circumference of the filtration chamber 31. The filtration chamber 31 and the cylindrical filter 32 may be concentric around a same axis extending along the length of the cleaner 1. In a case of the main body 3 which forms an outer circumferential boundary or appearance of the filtration chamber 31, a plurality of outer exhaust holes 33 are formed.

The blower 10 is accommodated inside the main body 3 in a state in which a portion of the blower 10 is inserted in the exhaust chamber 30. That is, the blower 10 which is in the main body 3 may include a blower portion in the exhaust chamber 30.

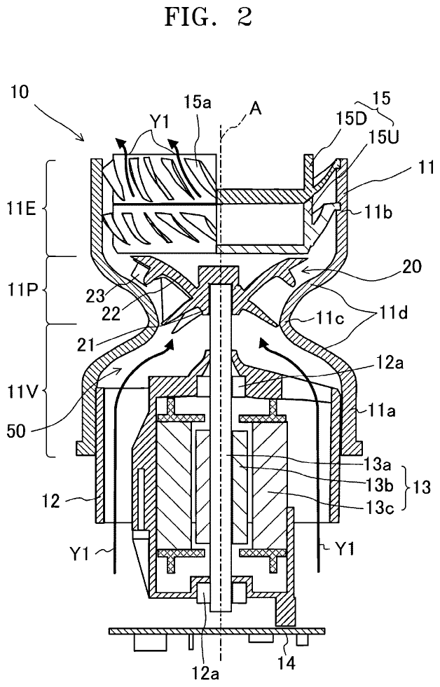

FIG. 2 is an enlarged cross-sectional view of the blower 10 according to an embodiment of the present disclosure. Referring to FIG. 2, the blower 10 may include a shroud 11 with a flow path (air passage 50) through which air flows, an impeller 20, and a motor 13 which is connected to the impeller 20 and rotates the impeller 20. The impeller 20 is disposed in the main body 3 and generates a suction force along a length of the cleaner 1 for suctioning air from the dust case 4 to the main body 3, through the air passage 50, while rotating. The blower 10 may further include a diffuser 15. In FIG. 2, a external shape (e.g., exterior) of the diffuser 15 is shown on the left side relative to a rotation axis A and a cross-sectional shape of the diffuser 15 is shows on the right side relative to the rotation axis A.

The shroud 11 covers the outside of the air passage 50 such as to function as a housing of the blower 10. When the impeller 20 rotates about the rotation axis A, the air in the air passage 50 flows in an air flow direction Y1 in FIG. 2. Hereinafter, an ‘upstream side’ and a ‘downstream side’ are defined along the air flow direction Y1. The shroud 11 may be a cylindrical member having a concave center portion defined along a length of the blower 10 (e.g., vertical in FIG. 2). The shroud 11 may include an upstream large-diameter portion 11a (e.g., a first portion) with a relatively large inner diameter, a small diameter portion 11c (e.g., a second portion) with a smallest inner diameter among diameters of the shroud 11 which are located at various positions along a length of the shroud 11, and a downstream large-diameter portion 11b (e.g., a third portion) with a relatively large inner diameter. The small diameter portion 11c is positioned between the upstream large-diameter portion 11a and the downstream large-diameter portion 11b and has an outer dimension which is smaller than an outer dimension of both the upstream large-diameter portion 11a and the downstream large-diameter portion 11b.

Within the shroud 11, a relay area 11d is provided in each of a downstream portion of the upstream large-diameter portion 11a and an upstream portion of the downstream large-diameter portion 11b. Each relay region 11d has a shape in which an inner diameter gradually decreases from each of the upstream large-diameter portion 11a and the downstream large-diameter portion 11b, in a direction toward the small diameter portion 11c. Here, a first diameter at a respective large-diameter portion transitions to a second diameter smaller than the first diameter, for example, at the relay region 11d and the small diameter portion 11c.

Referring to FIGS. 1A to 1C, together with FIG. 2, the downstream large-diameter portion 11b is disposed inside and overlaps the exhaust chamber 30. The upstream large-diameter portion 11a is arranged to be partially inserted into and overlap the dust case 4, with a periphery of the upstream large-diameter portion 11a being covered by a filter case 4a capable of removing dust in the air.

From a functional point of view of the air passage 50, the shroud 11 may include a moving blade portion 11P, a suction portion 11V extending upstream from the moving blade portion 11P, and a static blade portion 11E extending downstream from the moving blade portion 11P.

The moving blade portion 11P may include a portion extending from the small diameter portion 11c and through the relay area 11d of the downstream large-diameter portion 11b. Accordingly, the moving blade portion 11P has a shape whose inner diameter gradually increases from the upstream side to the downstream side of the shroud 11. The impeller 20 is accommodated in the moving blade portion 11P. The impeller 20 is accommodated in the moving blade portion 11P such that each of the plurality of blades 23 faces the inner surface of the moving blade portion 11P with a tip clearance therebetween. That is, a distal end of each blade 23 among the blades 23 is spaced apart from an inner surface of the shroud 11 at the moving blade portion 11P, by a gap. The gap may define the tip clearance along a radial direction of the rotation axis A, from the blade distal end to the shroud inner surface.

The suction portion 11V may include the upstream large-diameter portion 11a, and through the relay area 11d connecting the upstream large-diameter portion 11a to the small-diameter portion 11c. Therefore, the inner diameter of the suction portion 11V gradually becomes smaller from the upstream side of the air passage 50 to the downstream side of the air passage 50. Here, the air inside the suction portion 11V flows from outside shroud 11 to inside the shroud 11, in a diameter direction along an inner surface of the suction portion 11V. The motor 13 is accommodated in the suction portion 11V.

The static blade portion 11E may include the downstream large-diameter portion 11b. The diffuser 15 is accommodated in the static blade portion 11E.

The motor 13 may include a shaft 13a, a rotor 13b, and a stator 13c. A motor case 12 is inserted into and accommodated in the upstream large-diameter portion 11a. At the center of the motor case 12, the shaft 13a is rotatably supported by a bearing 12a. A rotor 13b is fixed to a middle portion of the shaft 13a. The stator 13c is assembled to the motor case 12 such that the stator 13c is positioned around the rotor 13b with a gap therebetween. Accordingly, the motor 13 including the shaft 13a, the rotor 13b, and the stator 13c is disposed at a central portion of the suction portion 11V. The motor 13 is integrated with the motor case 12, such as to be connected thereto in a single body. The rotation axis A of the motor 13 coincides with respective centers of the motor case 12 and the shroud 11. A length of the shaft 13a may correspond to or be aligned with the rotation axis A, such that the motor 13 is rotatable about the rotation axis A.

One end portion of the shaft 13a protrudes from the motor case 12. The motor case 12 is inserted into the shroud 11 such that the protruding end portion of the shaft 13a extends in the downstream direction. Accordingly, the air passage 50 described above is formed between the motor 13 and the inner surface of the suction portion 11V of the shroud 11, that is, the inner surface of the upstream large-diameter portion 11a.

A controller 14 for controlling the motor 13 may be installed on the upstream side of the motor case 12. The controller 14 may include a printed circuit board on which an electronic component such as a motor driving integrated circuit (IC) is mounted. For example, the motor 13 is located upstream of the impeller 20 within the air passage 50, and the controller 14 is disposed upstream of the motor 13 within the air passage 50. The controller 14 may be arranged so that the printed circuit board faces the air passage 50. Here, the printed circuit board may have a major surface (e.g., defined in FIG. 2 along a horizontal direction and a direction into the page view), where such major surface faces an open end of the air passage 50. The controller 14 controls the driving of the motor 13 according to a signal (e.g., an electrical signal) for operating the cleaner 1.

The motor 13 may be relatively small (e.g., a palm size). For example, according to the present embodiment, the stator 13 may have a palm size by having an outer diameter of about 40 millimeters (mm) and a height of about 70 mm. Accordingly, the motor 13 may also be very light in weight.

The motor 13 may have a structure capable of obtaining a high output with a high efficiency, so as to obtain sufficient performance which may be used in the cleaner 1 by using power of the battery 6. For example, the motor 13 according to an embodiment of the present disclosure may have a structure capable of obtaining suction power of 250 watts (W) or more by being driven at a high speed rotation of 50,000 rpm or more, at an ultra-high speed rotation of 100,000 rpm or more, even at an ultra-high speed rotation of 130,000 rpm or more, with consumption power of 600 W.

The diffuser 15 may be accommodated in the static blade portion 11E. According to the present embodiment, the diffuser 15 may include an upper diffuser 15U and a lower diffuser 15D. The diffuser 15 may be provided in a quantity of one or a quantity of three or more according to specifications of the blower 10.

Each of the upper diffuser 15U and the lower diffuser 15D may be a cylindrical member. A plurality of vanes 15a extend obliquely with respect to an axial direction (for example, the rotation axis A) is formed at the outer circumferential surface of each of the upper diffuser 15U and the lower diffuser 15D. An inclination angle of each of the vanes 15a in the lower diffuser 15D may be smaller than that of the vanes 15a in the upper diffuser 15U. Each of the upper diffuser 15U and the lower diffuser 15D may be fixed to the shroud 11 at an inner circumferential surface of the downstream large-diameter portion 11b.

As described above, the impeller 20 is disposed at the moving blade portion 11P of the shroud 11 having the air passage 50 defined therein. The impeller 20 includes a boss portion 21 at which the impeller 20 is fixed to the shaft 13a of the motor 13 which is aligned with the rotation axis A, a base portion 22 extending around the boss portion 21 and having an annular shape, and a plurality of blades 23. The plurality of blades 23 is arranged radially on the base portion 22 and generates a suction force in the air passage 50.

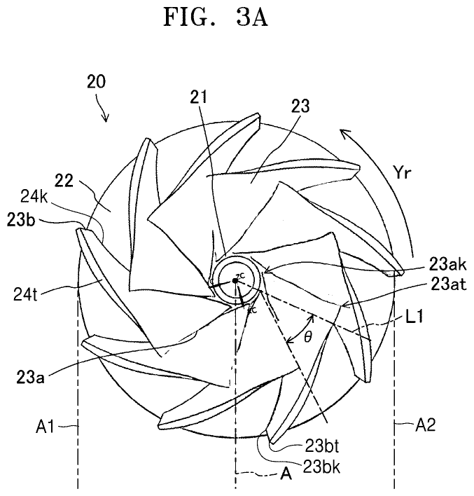

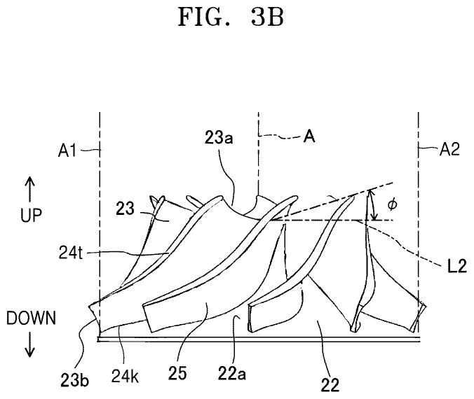

During an operation of the cleaner 1, the impeller 20 is rotated about the rotation axis A, by the motor 13, and thus rotates at relatively high speed in a certain direction. In the present embodiment, the certain direction is in a counterclockwise direction (see FIG. 3A) when viewed from the upstream side (e.g., at the UP side) and in the DOWN direction. Accordingly, as indicated by an arrow Y1 in FIG. 2, air enters the shroud 11 from the dust case 4 via the motor case 12, and thus, a suction force is generated at an upstream side of the moving blade portion 11P, namely, the suction portion 11V.

The air entered the shroud 11 is sucked into the moving blade portion 11P while cooling the controller 14 or the motor 13 in an air-cooling manner. Since the amount of heat generated by the controller 14 and the motor 13 increases with increased speed or high suction power, it is important to cool them. In the blower 10 according to an embodiment of the present disclosure, since the motor 13 is disposed on the upstream side of the moving blade portion 11P, heat exchange between air of relatively low temperature which is the same as that of the outside air (e.g., air incident into the cleaner 1), and air of relatively high temperature (e.g., a temperature higher than that of the outside air) at the controller 14 and the motor 13 is possible. Accordingly, the cooling property of the controller 14 or the motor 13 is excellent.

The air is concentrated within the suction part 11V while bending from the outer circumference of the suction portion 11V to the center thereof, and flows to the moving blade portion 11P. In detail, the air flows in an axial direction along the inner surface of the upstream large-diameter portion 11a and along a lateral portion of the motor 13, and then flows from an outer circumference side (outside in the diameter direction) toward a center side (inside in the diameter direction) along an inner surface of the relay area 11d of the upstream large-diameter portion 11a and along the lateral portion of the motor 13 and is directed toward the moving blade portion 11P Therefore, air may flow in efficient contact with the controller 14 and/or the motor 13, and thus heat exchange with the controller 14 or the motor 13 is easy. As being in contact, elements may form an interface therebetween. Accordingly, the cooling property of the controller 14 or the motor 13 is improved.

The air entered the moving blade portion 11P passes through a space or gap between an inner surface of the shroud 11 at the moving blade portion 11P and an outer area of the impeller 20 at the base portion 22 (specifically, at gaps defined between the blades 23), and enters the static blade portion 11E. The air entered the static blade portion 11E passes through a space or a gap between an inner surface of the shroud 11 at the static blade portion 11E and an outer circumferential surface of the diffuser 15 (specifically, between the vanes 15a) and enters the exhaust chamber 30.

The air enters the exhaust chamber 30 while being rectified in the axial direction by passing through the diffuser 15. The air entered the exhaust chamber 30 flows radially out into the filtration chamber 31 through the inner exhaust holes 30a and is exhausted out of the main body 3 through the outer exhaust holes 33.

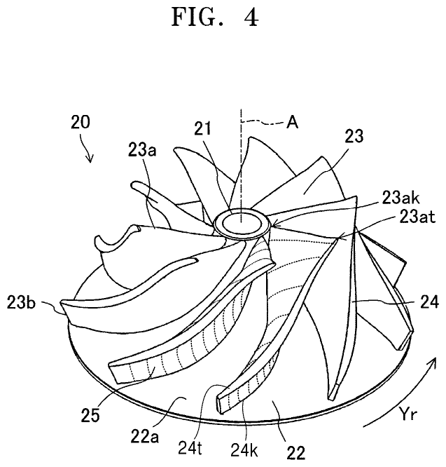

FIGS. 3A and 3B respectively illustrate a top plan view and a side view of the impeller 20 according to an embodiment of the present disclosure. FIG. 4 is a perspective view of the impeller 20 according to an embodiment of the present disclosure.

Referring to FIGS. 3A to 3C and 4, as described above, the impeller 20 includes the boss portion 21, the base portion 22, and the plurality of blades 23. For example, the impeller 20 may be formed or provided by integrally forming the boss portion 21, the base portion 22, and the plurality of blades 23 with each other into a single, unitary body. For example, the impeller 20 may be a resin molded product. In FIGS. 3B and 4, the impeller 20 is shown with the upstream side of the air passage 50 (a protruding end side of the boss portion 21) facing upward. For convenience of descriptions, as shown in FIG. 3B, the protruding end side of the boss portion 21 (an upstream side of the air passage 50) is referred to as an ‘upper side’, and an opposite side thereof along the rotation axis A is referred to as a ‘lower side’.

The impeller 20 is also relatively small, like the motor 13. For example, as a small size, an outer diameter of the impeller 20 may be about 10 mm to about 50 mm. According to the present embodiment, the impeller 20 may have a relatively small size (e.g., a palm size) corresponding to an outer diameter of about 40 mm. When the motor 13 is driven, the impeller 20 rotates counterclockwise when viewed from the top, as indicated by arrow Yr in FIGS. 3A and 4. Of course, when the shape of the impeller 20 is opposite to which shown in FIGS. 3A and 4, the impeller 20 rotates in a direction opposite to the arrow Yr.

The impeller 20 fixed to the shaft 13a at the boss portion 21 with a protruding end side of the impeller 20 facing toward the upstream side of the air passage 50. The impeller 20 include an annular base portion 22 having an annular shape which slopes downward to define a diameter which increases in a direction from the protruding end side of the boss portion 21 to a proximal end side thereof, that is, in a direction from the upstream side of the air passage 50 to the downstream side of the air passage 50. Accordingly, an inclined surface 22a forms a portion of the upper surface of the base portion 22, where the inclined surface 22a slopes and has a gradually increasing diameter in a direction from the protruding end side of the boss portion 21 to the proximal end side thereof, that is, from the upstream side of the air passage 50 to the downstream side thereof. The inclined surface 22a is curved gently upward to be concave in a direction from an inner circumference side to an outer circumference side (at A1 and A2 in FIGS. 3A and 3B). An inclination angle of the inclined surface 22a may be about 30 degrees (.), such as within a range from about 20° to about 40°. The inclined surface 22a may be exposed to outside the impeller 20 at locations between adjacent blades 23.

Each blade 23, which has a thin plate shape, protrudes from the inclined surface 22a of the base portion 22. Each blade 23 extends so as to gradually shift backward along the inclined surface 22a with respect to the rotational direction Yr (e.g., in a direction opposite to the rotational direction Yr) in a radial direction, from a position along the lateral side of the boss portion 21. That is, each blade 23 is inclined such that its outer circumferential side is located behind its central side in the rotational direction Yr. When the impeller 20 rotates, air flows out of the impeller 20 through gaps between the plurality of blades 23, in a direction inclined with respect to the rotation axis A.

The impeller 20 according to an embodiment of the present disclosure includes nine blades 23 arranged at equidistant intervals along the inclined surface 22a, in a circumferential direction. Each blade 23 may be provided with two edges 23a and 23b spaced apart from each other along the diameter direction (e.g., horizontal in FIGS. 3A and 3B), and two edges 24k and 24t spaced apart from each other in a vertical direction (e.g., vertical in FIG. 3B), that is, in the direction of the rotation axis A. The blade 23 may meet the inclined surface 22a at the edge 24k.

Each blade 23 has an outer appearance of a strip type in which one edge 23a among the two edges 23a and 23b in a radial direction is longer and the other edge 23b is shorter. The longer edge (wind-cutting edge) 23a of the two edges 23a and 23b in the radial direction is positioned on a center side of the base portion 22, that is, closest to the boss portion 21, and the shorter edge (wind-sending edge) 23b is positioned on an outer circumferential side of the base portion 22, that is furthest from the boss portion 21. The wind-cutting edge 23a includes a proximal end 23ak on the side of the blade 23 corresponding to the base portion 22, and a protruding end 23at spaced apart from the base portion 22. The proximal end 23ak is an end of the blade 23 at which the blade 23 is connected to or meets the inclined surface 22a of the base portion 22, and the protruding end 23at is an end of the blade 23 which is connected to the proximal end 23ak and is spaced apart from the inclined surface 22a of the base portion 22. The wind-sending edge 23b includes a proximal end 23bk on the side of the blade 23 corresponding to the base portion 22 and a protruding end 23bt spaced apart from the base portion 22. The proximal end 23bk is an end of the blade 23 at which the blade 23 is connected to or meets the inclined surface 22a of the base portion 22, and the protruding end 23bt is an end of the blade 23 which is connected to the proximal end 23bk and is spaced apart from the inclined surface 22a of the base portion 22.

Each blade 23 includes a wing root edge 24k and a wing tip edge 24t. The wing root edge 24k is an edge of the blade 23 connecting the proximal end 23ak of the wind-cutting edge 23a to the proximal end 23bk of the wind-sending edge 23b, and is an edge of the blade 23 at which the blade 23 is connected to or meets an upper surface of the base portion 22, that is, the inclined surface 22a. The wing tip edge 24t is an edge of the blade 23 connecting the protruding end 23at of the wind-cutting edge 23a to the protruding end 23bt of the wind-sending edge 23b, and is an edge of the blade 23 which is spaced upward from the upper surface of the base portion 22, that is, the inclined surface 22a. As shown in FIG. 3B and in FIG. 4, a front surface of each blade 23 with respect to the rotational direction Yr is a pressure surface 25. The pressure surface 25 is a leading surface of the blade 23 in the rotational direction Yr.

Each blade 23 may have a twisted shape in which the plate of the blade 23 has a shape twisted from the wind-cutting edge 23a toward the wind-sending edge 23b. The wind-cutting edge 23a is inclined while being twisted in the rotational direction Yr in a direction from the proximal end 23ak to the protruding end 23at, and the wind-sending edge 23b is inclined while being twisted in an opposite direction of the rotational direction Yr from the proximal end 23bk to the protruding end 23bt. The wind-cutting edge 23a extends, as shown in FIG. 3A, in the diameter direction, as seen in the direction of the rotational axis A. Accordingly, a blade surface defined by the wing tip edge 24t of each blade 23 (edge spaced upwards apart from the base portion 22) faces an inner circumferential surface of the shroud 11 at the moving blade portion 11P with a tip clearance (e.g., gap) therebetween.

In each blade 23, the protruding end 23at of the wind-cutting edge 23a is positioned behind the proximal end 23ak of the wind-cutting edge 23a based on the rotational direction Yr. For convenience, this shape of the blade 23 is referred to as a swept-back wing shape. Due to the swept-back wing shape, air resistance of the blade 23 is reduced, so that an impeller 20 having the swept-back wing shape which is advantageous for high-speed rotation may be realized. Referring to FIG. 3A, an angle by which the wind-cutting edge 23a is inclined with respect to a reference line L1 extending from the rotational axis A in the radial direction is referred to as a swept-back angle θ. The reference line L1 may be a virtual line in the radial direction which corresponds to the proximal end 23ak of the wind-cutting edge 23a. The swept-back angle θ may be about 30° to about 50°. A line substantially corresponding to the wind-cutting edge 23a may be used in determining the swept-back angle θ.

In the case of the impeller 20 according to an embodiment of the present disclosure, the protruding end 23at of the wind-cutting edge 23a is positioned at a higher location (the upstream side of the air passage 50) than the proximal end 23ak of the wind-cutting edge 23a, along a thickness direction of the impeller 20 (e.g., vertical in FIG. 3B). In detail, referring to FIG. 3B, the wind-cutting edge 23a of each blade 23 is inclined to protrude upward in a direction from the proximal end 23ak to the protruding end 23at, namely, protrude upstream of the blower 10. By forming the wind-cutting edge 23a of each blade 23 in this shape, a blade load at an end of each blade 23 located on an air inlet side (e.g., the upstream side) may be reduced, and leakage flow may be reduced. Referring to FIG. 3B, an angle at which a line substantially corresponding to the wind-cutting edge 23a is inclined with respect to a reference line L2 which is orthogonal to the rotation axis A, is referred to as an inclination angle φ. The inclination angle φ may be about 10° to about 30°.

The blade 23 may have a shape which may correspond to high-speed rotation or ultra-high-speed rotation. According to an embodiment, as schematically shown by a broken line pattern in FIG. 4, a lateral surface of the blade 23 facing forward in the rotational direction Yr, that is, the pressure surface 25, is curved concavely toward the rotational direction Yr. In other words, in a cross section of the blade 23 cut in the vertical direction, a surface facing in the rotational direction Yr is a concave surface. According to the present embodiment, the cross section of the blade 23 cut in the vertical direction is overall concavely curved. The pressure surface 25 may define a major surface of the blade 23 which faces in the rotational direction Yr.

A comparative impeller blade may have a flat shape where the cross section of the pressure surface 25 is straight or planar (e.g., in a single plane). Fluid analysis on the shape of the blade 23 was performed relative to high-speed or ultra-high-speed rotation. As a result of such fluid analysis, it was confirmed that a difference between air flow velocities in the moving blade portion 11P during high-speed rotation and ultra-high-speed rotation was reduced by changing the pressure surface 25 of each blade 23 from a comparative flat plate shape to the above-described curved shape in one or more embodiment of the present invention. Thus, a leakage vortex may be suppressed by the curved-shape impeller blade, thereby reducing (air) friction loss and (air) mixing loss. Therefore, energy efficiency may be improved by forming the pressure surface 25 of each blade 23 according to one or more embodiment of the present invention into the above-described curved shape. Energy efficiency may be defined as a value obtained by dividing the suction power by the amount of power supplied.

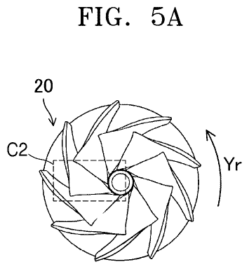

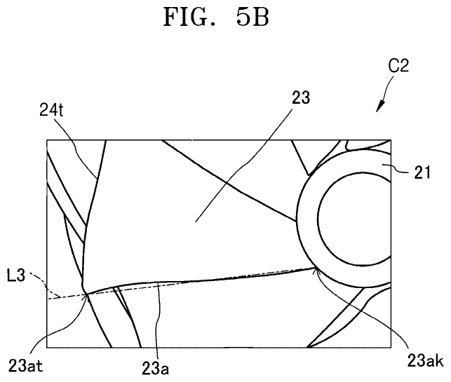

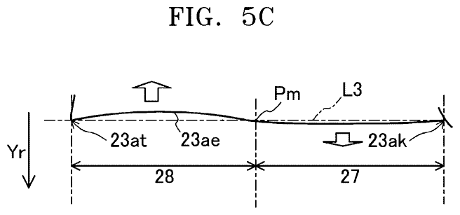

FIG. 5A illustrates a top plan of a wind-cutting edge of a blade according to an embodiment of the present disclosure. FIG. 5B illustrates an enlarged top plan view of region C2 in FIG. 5A. FIG. 5C illustrates a side view of the blade in FIG. 5B.

According to an embodiment, the blade 23 has a shape capable of corresponding to high-speed rotation or ultra-high-speed rotation, and the wind-cutting edge 23a of the blade 23 may have a certain curved shape. FIGS. 5A through 5C are views view for explaining the wind-cutting edge 23a as a lead edge of the blade 23 according to an embodiment of the present disclosure.

Referring to FIGS. 5A to 5C, when viewed from a normal direction with respect to the lateral surface of the blade 23 (more particularly, a portion of the lateral surface of the blade 23 which is close to the wind-cutting edge 23a), a portion close to the proximal end 23ak of the wind-cutting edge 23a, for example, from the proximal end 23ak of the wind-cutting edge 23a to a midpoint Pm of the wind-cutting edge 23a, is convexly curved toward or in the rotational direction Yr, and a portion close to the protruding end 23at of the wind-cutting edge 23a, for example, from the midpoint Pm of the wind-cutting edge 23a to the protruding end 23at of the wind-cutting edge 23a, is concavely curved in a direction opposite to the rotational direction Yr.

As briefly shown in FIG. 5C, when a line connecting the proximal end 23ak of the wind-cutting edge 23a to the protruding end 23at of the wind-cutting edge 23a is referred to as a reference line L3, an edge line 23ae of the wind-cutting edge 23a from the proximal end 23ak of the wind-cutting edge 23a to the midpoint Pm of the wind-cutting edge 23a is located ahead of the reference line L3 based on the rotational direction Yr, and an edge line 23ae of the wind-cutting edge 23a from the midpoint Pm of the wind-cutting edge 23a to the protruding end 23at of the wind-cutting edge 23a is located behind the reference line L3 based on the rotational direction Yr. In other words, it may be considered that the wind-cutting edge 23a has a protruding curved portion 27 convexly curved in the rotational direction Yr at a position adjacent to (e.g., closest to) the proximal end 23ak of the wind-cutting edge 23a, and a recessed curved portion 28 concavely curved in an opposite direction of the rotational direction Yr at a position adjacent to (e.g., closest to) the protruding end 23at of the wind-cutting edge 23a. The recessed curved portion 28 is formed to have a greater degree of curvature and a smaller radius of curvature than the protruding curved portion 27.

According to fluid analysis, it was confirmed that, by giving the wind-cutting edge 23a this curved shape, the air flow at an inlet portion of the moving blade portion 11P can be improved when the impeller 20 rotates at high speed.

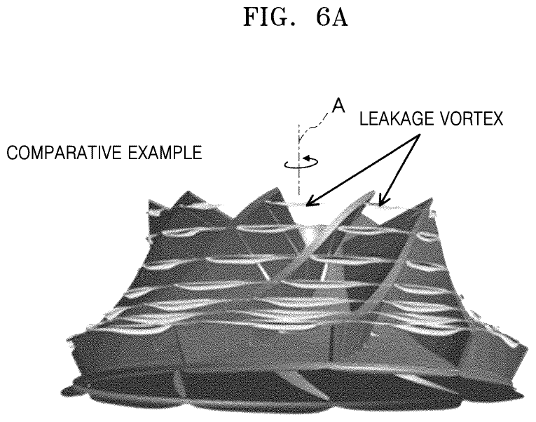

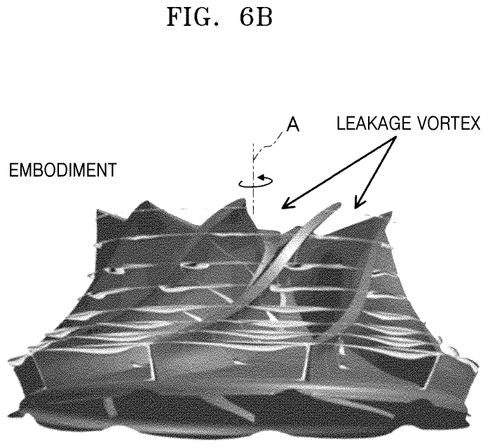

FIGS. 6A and 6B are side view illustrating fluid analysis results of an impeller according to a Comparative Example and to an embodiment of the present disclosure FIGS. 6A ad 6B is a diagram showing examples of fluid analysis results. In FIG. 6A, an impeller of a Comparative Example is a comparative impeller in which a comparative wind-cutting edge of a comparative blade is straight (e.g., flat or planar). In FIG. 6B, an impeller according to an embodiment is the impeller 20 in which the wind-cutting edge 23a of each blade 23 is formed in the above-described curved shape. In a fluid analysis, a rotation speed of the impeller 20 is set to 130,000 rpm. FIGS. 6A and 6B visually display air flows at a certain region of the moving blade portion 11P (refer to FIG. 2) for a Comparative Example and an embodiment. In detail, a plurality of regions are selected along the wing tip edge 24t of the blade 23, and the state of an air flow at a tip clearance between the inner surface of the shroud 11 at the moving blade portion 11P and a corresponding region of the wing tip edge 24t of the blade 23 is visualized.

As indicated by an arrow in FIG. 6A, a disturbance (leakage vortex) in the air flow occurs between two adjacent blades 23 within the tip clearance. These leakage vortices act as air resistance to the rotation of the impeller 20. Therefore, in order to improve energy efficiency, suppression of this leakage vortex is important.

Regarding the leakage vortex at the inlet portion of the moving blade portion 11P in FIG. 6B, it may be seen that the leakage vortex was suppressed (e.g., less pronounced ‘air’ features at the upper area of the impeller 20 in FIG. 6B) and reduced in the case of an embodiment, compared to the more pronounced ‘air’ features at the upper area of the comparative example in FIG. 6A. Therefore, by forming the wind-cutting edge 23a of the blade 23 into the above-described curved shape, the leakage vortex occurring at the inlet side of the moving blade portion 11P may be effectively suppressed, thereby increasing a suction force within a suction device and improving energy efficiency.

A cleaner 1 as a suction device according to the present disclosure and an impeller 20 employed therein, are not limited to the above-described embodiments. For example, the cleaner 1 is not limited to a stick type cleaner, and may be another suction device such as a robot cleaner or an upright cleaner. In addition, the shape of the inclined surface 22a of the base portion 22 is not limited to a downwardly curved shape, and may be an upwardly curved shape or may be a shape inclined at a certain angle without being curved (e.g., linearly inclined).

According to an aspect of the present disclosure, a cleaner includes a main body through which air is exhausted from the cleaner, the main body including a filtration chamber and an exhaust chamber, a dust case connected to the main body, an air passage which is in the dust case and is extended from the dust case to the main body in an airflow direction, an impeller which rotates in the main body portion in a rotational direction and generates a suction force within the air passage in the airflow direction, the impeller including a boss portion, a base portion extending in a radial direction from the boss portion, the base portion having a diameter which increases in the airflow direction, and blades extending in the radial direction from the boss portion, The blades include a wind-cutting edge facing the airflow direction. The wind-cutting edge includes a proximal end which is closest to the boss portion along the radial direction and meets the base portion, a protruding end which is furthest from the boss portion along the radial direction and is spaced apart from the base portion along the airflow direction, a protruding curved portion which is convexly curved in the rotational direction, and a recessed curved portion which is concavely curved in a direction opposite to the rotational direction, the recessed curved portion being closer to the protruding end of the wind-cutting edge than the protruding curved portion, and a motor which rotates the impeller, the impeller including a shaft which is connected to the impeller and rotates in the rotational direction.

According to fluid analysis, due to a wind-cutting edge including a protruding curved portion and a recessed curved portion, a leakage vertex which occurs at the entrance of an air passage, where an impeller is located, during high-speed rotation and become air resistance may be suppressed. Therefore, a suction force may be improved, and energy efficiency may be improved.

According to an embodiment, based on a reference line connecting the proximal end of the wind-cutting edge to the protruding end of the wind-cutting edge, a portion of the wind-cutting edge which is close to the proximal end may protrude in the rotational direction more than the reference line, and a portion of the wind-cutting edge which is close to the protruding end may be more concave in the direction opposite to the rotational direction than the reference line. Here, based on a reference line (L1) which extends along the radial direction and connects the proximal end of the wind-cutting edge to the protruding end of the wind-cutting edge, the protruding curved portion of the wind-cutting edge protrudes from the reference line in the rotational direction and the recessed curved portion of the wind-cutting edge is recessed from the reference line in a direction opposite to the rotational direction.

According to an embodiment, the amount of curvature of the recessed curved portion may be greater than the amount of curvature of the convex curved portion. According to an embodiment, the radius of curvature of the recessed curved portion may be less than the radius of curvature of the convex curved portion. Here, a curvature of the recessed curved portion which is concavely curved is greater than a curvature of the protruding curved portion which is convexly curved.

According to an embodiment, the base portion may include an inclined surface which slopes downward from the upstream side of the air passage toward the downstream side of the air passage and has a diameter which gradually increases from the upstream side of the air passage toward the downstream side of the air passage. The plurality of blades may protrude from the inclined surface, and may each extend to be shifted backward with respect to the rotational direction as going in a radial direction from the boss portion. Here, the base portion includes an inclined surface which outwardly slopes from the boss portion to define the diameter of the base portion which increases in the airflow direction, and the blades protrude from the inclined surface of the base portion, in a direction opposite to the airflow direction, and are tilted backward in a direction opposite to the rotational direction. Accordingly, when the impeller rotates, the air inside the air passage may pass through gaps between the plurality of blades and may escape outward in the radial direction.

According to an embodiment, each of the plurality of blades may have a swept-back wing shape in which the protruding end of the wind-cutting edge is located behind the proximal end of the wind-cutting edge with respect to the rotational direction. Here, within the swept-back wing shape, each of the blades which is tilted backward includes the protruding end of the wind-cutting edge behind the proximal end of wind-cutting edge with respect to the rotational direction. Each of the blades which is tilted backward further includes a major surface which faces in the rotational direction and is concavely curved. According to the blade having the swept-back wing shape, air resistance is reduced, and thus the impeller is advantageous for high-speed or ultra-high-speed rotation.

According to an embodiment, a swept-back angle of the wind-cutting edge may be about 30° to about 50°. Here, based on a virtual line (reference line L1) which corresponds to the proximal end of the wind-cutting edge and extends in the radial direction from the boss portion, the wind-cutting edge forms a swept-back angle of about 30° to about 50°. Accordingly, the swept-back wing shape may be optimized, and thus air resistance may be effectively reduced.

According to an embodiment, the wind-cutting edge may be inclined to protrude toward an upstream side of the air passage in a direction from the proximal end to the protruding end. Here, the wind-cutting edge is inclined in the airflow direction from the proximal end to the protruding end. Thus, a blade load at an end located on an air inlet side of the blade may be reduced, and leakage flow may also be reduced. Here, based on a virtual line (reference line L2) which extends in the radial direction, the wind-cutting edge is inclined at an inclination angle of about 10° to about 30°. According to an embodiment, an inclination angle of the wind-cutting edge may be about 10° to about 30°.

According to an embodiment, the cleaner may include a shroud configured to form the air passage. The shroud may include a moving blade portion 11P with an inner diameter gradually increasing in a direction from an upstream side to a downstream side, in which the impeller is accommodated such that each of the plurality of blades faces an inner surface of the moving blade portion with a tip clearance therebetween, a suction portion 11V extending from the moving blade portion to the upstream side, and a static blade portion 11E extending from the moving blade portion to the downstream side. An inner diameter of the suction portion may gradually become smaller from the upstream side of the air passage to the downstream side of the air passage so that the air flows along the inner surface of the suction portion from outside to inside in a diameter direction within the suction portion. The motor may be disposed in the suction portion. Here, the cleaner further includes a shroud including a suction portion in which the motor is disposed, a moving blade portion in which the impeller is disposed, and a static blade portion, in order in the airflow direction, and an inner surface which defines the air passage and at which an inner diameter of the shroud is defined, the inner surface being defined at each of the suction portion, the moving blade portion and the static blade portion. The inner diameter of the shroud at the suction portion decreases in the airflow direction and the inner diameter of the shroud at the moving blade portion increases in the airflow direction. Within the moving blade portion, tips of the impeller face the inner surface of the shroud and are spaced apart from the inner surface by a tip clearance. Within the suction portion, the suction force moves air within the air passage along the radial direction in a direction away from the inner surface of the shroud.

Since the amount of heat generated by the motor increases as speed increases, it is important to cool the motor. Since the motor is disposed in a suction section, that is, on the upstream side of the moving blade portion, heat exchange between air with a relatively low temperature which is the same as that of the outside air, and the motor is possible. Therefore, the motor may be effectively cooled. In addition, a downstream portion of the suction portion is formed so that an inner diameter gradually decreases from the upstream side to the downstream side, and thus the air in the suction portion flows from outside to inside in the diameter direction along the inner surface of the suction portion. Accordingly, the air may efficiently contact the motor, making it easy to exchange heat between the air and the motor, thereby improving cooling performance.

According to an embodiment, the cleaner may further include a controller 14 configured to control the motor. Here, the controller is connected to the motor and controls the motor. The motor is in the dust cover, within the air passage, and within the air passage, the controller and the motor are in order in the airflow direction. In the air passage, the motor may be located on an upstream side of the impeller. The controller may be located on an upstream side of the motor. Accordingly, the motor and the controller may be effectively cooled by external air. In such air-cooling, the suction force within the air passage draws air from outside the cleaner and into the air passage at the dust cover, through a cleaner head connected to the dust cover via the air passage, and within the air passage at the dust cover, the air from outside of the cleaner contacts the controller and motor which air-cools the controller and the motor within the cleaner.

According to an aspect of the present disclosure, an impeller installed in an air passage to generate a suction force while being rotated by a motor includes a boss portion 21 to which a shaft of the motor is fixed, a base portion including an inclined surface which slopes downward from an upstream side of the air passage toward a downstream side of the air passage and has a diameter which gradually increases from the upstream side of the air passage toward the downstream side of the air passage, the base portion being connected to the boss portion, and a plurality of blades protruding from the inclined surface and each extending to be shifted backward with respect to the rotational direction in a radial direction from the boss portion. Here, an impeller of a cleaner includes a boss portion at which the impeller is connected to a motor which rotates the impeller in a rotational direction to generate a suction force within an air passage of the cleaner, in an airflow direction, a base portion which is connected to the boss portion and extends in a radial direction from the boss portion, the base portion including an inclined surface which outwardly slopes from the boss portion to define a diameter of the base portion which increases in the airflow direction, blades which protrude from the inclined surface of the base portion, in a direction opposite to the airflow direction, and are tilted backward in a direction opposite to the rotational direction, and each of the blades having a swept-back wing shape defined by a wind-cutting edge facing the airflow direction. The wind-cutting edge includes a proximal end which is closest to the boss portion along the radial direction and meets the base portion, a protruding end which is furthest from the boss portion along the radial direction and is spaced apart from the base portion along the airflow direction, a protruding curved portion which is convexly curved in the rotational direction, and a recessed curved portion which is concavely curved in a direction opposite to the rotational direction, the recessed curved portion being closer to the protruding end of the wind-cutting edge than the protruding curved portion.

Each of the plurality of blades has a swept-back wing shape, Each of the plurality of blades includes a wind-cutting edge close to the boss portion, The wind-cutting edge includes a proximal end on the side of the base portion and a protruding end spaced apart from the base portion. The wind-cutting edge includes a protruding curved portion convexly curved in a rotational direction of the impeller at a portion close to the proximal end, and a recessed curved portion concavely curved in a direction opposite to the rotational direction at a portion close to the protruding end.

According to an embodiment, a swept-back angle (θ) of the blade may be about 30° to about 50°. Here, based on a virtual line which corresponds to the proximal end of the wind-cutting edge and extends in the radial direction from the boss portion, the wind-cutting edge forms a swept-back angle of about about 30° to about 50°.

According to an embodiment, the wind-cutting edge may be inclined to protrude toward an upstream side of the air passage in a direction from the proximal end to the protruding end. That is, the wind-cutting edge is inclined in the airflow direction from the proximal end to the protruding end.

According to an embodiment, an inclination angle φ of the wind-cutting edge may be about 10° to about 30°. Here, based on a virtual line which extends in the radial direction, the wind-cutting is inclined at an inclination angle of about 10° to about 30°.

According to an embodiment, a cleaner includes a blower at which a suction force is generated in an airflow direction, a dust case at an air input of the blower, and an exhaust chamber at an air output of the blower. The blower includes a housing having an inner diameter and in which an air passage is defined, a motor which is in the housing and defines a portion of the air passage, an impeller which is in the air passage of the housing, connected to the motor, and rotates about a rotational axis and in a rotational direction to generate the suction force, and the inner diameter at the impeller being smaller than the inner diameter at the motor. The impeller of the blower includes a base portion extending in a radial direction relative to the rotational axis and having a diameter which increases in the airflow direction, and blades each extending in the radial direction along the base portion, tilted backward in a direction opposite to the rotational direction and including a wind-cutting edge facing the airflow direction. The wind-cutting edge of the each of the blades includes a proximal end which is closest to the rotational axis along the radial direction, a protruding end which is furthest from the rotational axis along the radial direction and is spaced apart from the base portion along the airflow direction, a protruding curved portion which is convexly curved in the rotational direction and a recessed curved portion which is concavely curved in the direction opposite to the rotational direction, the recessed curved portion being closer to the protruding end of the wind-cutting edge than the protruding curved portion.

The technical effects to be achieved in this document are not limited to the above-mentioned technical effects, and other technical effects not mentioned will be clearly understood by a person skilled in the art to which the present disclosure pertains from the following description.

As described above, although the cleaner and the impeller according to the present disclosure have been described using limited embodiments and drawings, the present disclosure is not limited to the above embodiments, and various modifications are possible without departing from the spirit thereof.

What is claimed is:

1. A cleaner comprising:
a main body through which air is exhausted from the cleaner, the main body including a filtration chamber and an exhaust chamber;
a dust case connected to the main body;
an air passage which is in the dust case and is extended from the dust case to the main body in an airflow direction;
an impeller which rotates in the main body in a rotational direction and generates a suction force within the air passage in the airflow direction, the impeller comprising:
a boss portion;
a base portion extending in a radial direction from the boss portion, the base portion having a diameter which increases in the airflow direction; and
blades extending in the radial direction from the boss portion, the blades including:
a wind-cutting edge facing the airflow direction; and
the wind-cutting edge including:
a proximal end which is closest to the boss portion along the radial direction and meets the base portion;
a protruding end which is furthest from the boss portion along the radial direction and is spaced apart from the base portion along the airflow direction;
a protruding curved portion which is convexly curved in the rotational direction; and
a recessed curved portion which is concavely curved in a direction opposite to the rotational direction, the recessed curved portion being closer to the protruding end of the wind-cutting edge than the protruding curved portion; and
a motor which rotates the impeller, the impeller comprising a shaft which is connected to the impeller and rotates in the rotational direction.

2. The cleaner of claim 1, wherein
based on a reference line which extends along the radial direction and connects the proximal end of the wind-cutting edge to the protruding end of the wind-cutting edge, the protruding curved portion of the wind-cutting edge protrudes from the reference line in the rotational direction and the recessed curved portion of the wind-cutting edge is recessed from the reference line in the direction opposite to the rotational direction.

3. The cleaner of claim 1, wherein
a curvature of the recessed curved portion which is concavely curved is greater than a curvature of the protruding curved portion which is convexly curved.

4. The cleaner of claim 1, wherein
a radius of curvature of the recessed curved portion which is concavely curved is less than a radius of curvature of the protruding curved portion which is convexly curved.

5. The cleaner of claim 1, wherein
the base portion includes an inclined surface which outwardly slopes from the boss portion to define the diameter of the base portion which increases in the airflow direction; and
the blades protrude from the inclined surface of the base portion, in a direction opposite to the airflow direction, and are tilted backward in the direction opposite to the rotational direction.

6. The cleaner of claim 5, wherein
each of the blades which is tilted backward includes the protruding end of the wind-cutting edge behind the proximal end of wind-cutting edge with respect to the rotational direction.

7. The cleaner of claim 6, wherein
each of the blades which is tilted backward further includes a major surface which faces in the rotational direction and is concavely curved.

8. The cleaner of claim 6, wherein
based on a virtual line which corresponds to the proximal end of the wind-cutting edge and extends in the radial direction from the boss portion, the wind-cutting edge forms a swept-back angle of about 30 degree to about 50 degrees.

9. The cleaner of claim 1, wherein
the wind-cutting edge is inclined in the airflow direction from the proximal end to the protruding end.

10. The cleaner of claim 9, wherein
based on a virtual line which extends in the radial direction, the wind-cutting edge is inclined at an inclination angle of about 10 degrees to about 30 degrees.

11. The cleaner of claim 1, further comprising a shroud which is in the dust case and is extended from the dust case to the main body in the airflow direction,
wherein the shroud comprises:
a suction portion in which the motor is disposed, a moving blade portion in which the impeller is disposed, and a static blade portion, in order in the airflow direction; and
an inner surface which defines the air passage and at which an inner diameter of the shroud is defined, the inner surface being defined at each of the suction portion, the moving blade portion and the static blade portion;
wherein
the inner diameter of the shroud at the suction portion decreases in the airflow direction and the inner diameter of the shroud at the moving blade portion increases in the airflow direction;
within the moving blade portion, tips of the impeller face the inner surface of the shroud and are spaced apart from the inner surface by a tip clearance; and
within the suction portion, the suction force moves air within the air passage along the radial direction in a direction away from the inner surface of the shroud.

12. The cleaner of claim 1, further comprising a controller which is connected to the motor and controls the motor,
wherein
the motor is in the dust cover, within the air passage; and
within the air passage, the controller and the motor are in order in the airflow direction.

13. The cleaner of claim 12, wherein
the suction force within the air passage draws air from outside the cleaner and into the air passage at the dust cover, through a cleaner head connected to the dust cover via the air passage; and
within the air passage at the dust cover, the air from outside of the cleaner contacts the controller and the motor and air-cools the controller and the motor within the cleaner.

14. An impeller of a cleaner, the impeller comprising:
a boss portion at which the impeller is connected to a motor which rotates the impeller in a rotational direction to generate a suction force within an air passage of the cleaner, in an airflow direction;
a base portion which is connected to the boss portion and extends in a radial direction from the boss portion, the base portion including an inclined surface which outwardly slopes from the boss portion to define a diameter of the base portion which increases in the airflow direction;
blades which protrude from the inclined surface of the base portion, in a direction opposite to the airflow direction, and are tilted backward in a direction opposite to the rotational direction; and
each of the blades having a swept-back wing shape defined by a wind-cutting edge facing the airflow direction, the wind-cutting edge including:
a proximal end which is closest to the boss portion along the radial direction and meets the base portion;
a protruding end which is furthest from the boss portion along the radial direction and is spaced apart from the base portion along the airflow direction;
a protruding curved portion which is convexly curved in the rotational direction; and
a recessed curved portion which is concavely curved in the direction opposite to the rotational direction, the recessed curved portion being closer to the protruding end of the wind-cutting edge than the protruding curved portion.

15. The impeller of claim 14, wherein
based on a virtual line which corresponds to the proximal end of the wind-cutting edge and extends in the radial direction from the boss portion, the wind-cutting edge forms a swept-back angle of about 30 degree to about 50 degrees.

16. The impeller of claim 15, wherein
the wind-cutting edge is inclined in the airflow direction from the proximal end to the protruding end.

17. The impeller of claim 16, wherein
based on a virtual line which extends in the radial direction, the wind-cutting is inclined at an inclination angle of about 10 degrees to about 30 degrees.

18. A cleaner comprising:
a blower at which a suction force is generated in an airflow direction;
a dust case at an air input of the blower; and
an exhaust chamber at an air output of the blower,
wherein
the blower comprises:
a housing having an inner diameter and in which an air passage is defined;
a motor which is in the housing and defines a portion of the air passage;
an impeller which is in the air passage of the housing, connected to the motor, and rotates about a rotational axis and in a rotational direction to generate the suction force; and
the inner diameter at the impeller being smaller than the inner diameter at the motor;
the impeller of the blower comprises:
a base portion extending in a radial direction relative to the rotational axis and having a diameter which increases in the airflow direction; and
blades each extending in the radial direction along the base portion, tilted backward in a direction opposite to the rotational direction and including a wind-cutting edge facing the airflow direction; and
the wind-cutting edge of the each of the blades includes:
a proximal end which is closest to the rotational axis along the radial direction;
a protruding end which is furthest from the rotational axis along the radial direction and is spaced apart from the base portion along the airflow direction;
a protruding curved portion which is convexly curved in the rotational direction; and
a recessed curved portion which is concavely curved in the direction opposite to the rotational direction, the recessed curved portion being closer to the protruding end of the wind-cutting edge than the protruding curved portion.

19. The cleaner of claim 18, wherein within the blower, the each of the blades which is tilted backward includes:
the protruding end of the wind-cutting edge behind the proximal end of wind-cutting edge with respect to the rotational direction, and
a major surface which faces in the rotational direction and is concavely curved.

20. The cleaner of claim 18, wherein within the blower, the each of the blades which is tilted backward includes:
based on a virtual line which corresponds to the proximal end of the wind-cutting edge and extends in the radial direction from the boss portion, the wind-cutting edge forming a swept-back angle of about 30 degree to about 50 degrees;
the wind-cutting edge inclined in the airflow direction from the proximal end to the protruding end; and
based on a virtual line which extends in the radial direction, the wind-cutting edge inclined at an inclination angle of about 10 degrees to about 30 degrees.
